(19) United States
(12) Patent Application Publication
(10) Pub. No.: US 2018/0106752 A1
(43) Pub. Date: Apr. 19, 2018

(54) Phosphate Electrode and a Method for Determining the Phosphate Concentration

(71) Applicant: Aqseptence Group GmbH, Aarbergen (DE)

(72) Inventor: Lars H. Wegner, Heidelberg (DE)

(21) Appl. No.: 15/555,009

(22) PCT Filed: Mar. 2, 2016
(86) PCT No.: PCT/EP2016/054360

§ 371 Date: Aug. 31, 2017

(30) Foreign Application Priority Data
Mar. 2, 2015 (DE) 10 2015 102 945.6

(51) Int. Cl. G01N 27/333; C03C 11/00; C03C 23/00; G01N 27/403

(52) U.S. Cl. CPC G01N 27/333; G01N 27/4035; C03C 23/0095; C03C 11/007

(57) ABSTRACT

The invention concerns a phosphate electrode with a base body (1) and a first coating (1a) provided at least in sections of the based body, wherein the base body comprises elemental cobalt and the first coating (1a) comprises a cobalt phosphate, wherein a second coating (1b) is applied at least in section onto the base body and/or the first coating, wherein the second coating binds protons and/or releases hydroxides. The invention further concerns a method for determination of the phosphate concentration with the phosphate electrode.

The present invention relates to a phosphate electrode with a base body and a first coating provided at least on sections of the base body, wherein the base body comprises elemental cobalt and the first coating comprises a cobalt phosphate. The invention further comprises a method for determining a phosphate concentration with the phosphate electrode.

In environmental analysis, the measurement of the phosphate concentration of aqueous samples is of great importance. The phosphate content of water is, e.g. a measure of the degree of eutrophication, i.e. the nutrient accumulation in waters. In sewage treatment plants, precise monitoring of the phosphate concentration, in particular in the activated sewage basin as well as in the effluent, is required to keep the phosphate discharging amount of the plant as low as possible via controlling the aerating phases and, if necessary, by precipitation.

The requirements for an analytical process suitable for sewage treatment plants include simple handling and high reliability with the lowest possible costs. A phosphate electrode fulfilling these criteria and which can be used directly for continuous measurement of phosphate in the activated sludge without further sample preparation is not yet available.

In practice, photometric methods are known, with which, however, phosphate contents can only be determined in individual samples and with high technical effort. An online measurement of the phosphate concentration, e.g. in the activated sludge, is not possible. The analysis used hitherto thus fulfills the stated criteria of a simple and fast handling with high reliability and low cost only inadequately.

An alternative to the previously mentioned methods is potentiometric measurements with ion-selective electrodes which are already routinely used in sewage treatment plants for the determination of nitrate and ammonium concentrations.

Ion-selective electrodes generate a voltage that is specific to the concentration of the ion to be determined in the medium surrounding the electrode. After a calibration against media with a known phosphate concentration, it is possible to conclude the phosphate content of an unknown aqueous solution on the basis of the measured potential value (e.g. a wastewater sample).

However, an unsolved problem with ion-selective electrodes is cross-sensitivity. In this case, potential or voltage changes at the electrode are caused by other ions (so-called interfering ions). As far as the voltage signal is no longer exclusively dependent on the concentration of the ion to be determined (also called analyte ion), it is also influenced by the concentration of the interfering ions.

In addition, not only interfering ions but also gases can lead to a voltage change by reaction with the electrode surface. Since in the case of the transverse sensitivity to gases in general a reaction upstream to the of the disturbance of the potential profile of the gases can take place to form corresponding anions, the underlying mechanism is the same as in the case of the cross-sensitivity of interfering ions.

Professional measures for reducing the cross-sensitivity of ion-selective electrodes include the use of ion-selective membranes and complex reference measurements, wherein the induced potential change of known interfering ions serves as a reference signal at different concentrations.

However, these measures have so far been unsuccessful in ion-selective phosphate electrodes. On the one hand, the reference measurements are extremely complex, so that a practical solution is lacking for the use of ion-selective phosphate electrodes in the daily measuring operation. On the other hand, ionselective membranes are extremely expensive and so far not sufficiently selective for phosphate ions. In addition, the ion-selective membranes have lower long-term stability and have been found to be susceptible to bacterial degradation.

DE 10 2009 051 169 A1 describes a phosphate electrode with a cobalt-based base body and a coating disposed thereon, which contains a phosphate salt of cobalt. This electrode has been found to be susceptible to interfering ions, because other anions, for example chlorides or nitrates, are absorbed relatively unspecifically at the electrodes surface and thereby cause a potential change of the electrode half-cell, which is why this electrode has to be improved for a practical application, such as the continuous measurement of the phosphate concentration in wastewater.

Chen, Z. L., Grierson, P., Adams, M. A., “Direct determination of phosphate in in soil extracts by potentiometric flow injection using a cobalt wire electrode”, Analytica Chimica Acta 363, 192-197, 1998 describes a phosphate electrode with a cobalt body, which is deposited with Co₃(PO₄)₂ under the measurement conditions. This causes a potential change to a reference electrode. Furthermore, it is described that, at a pH value above 5.0, the phosphate deposition is made difficult due to the formation of Co(OH)₂ on the cobalt surface, which is why a phosphate determination can only be carried out at a pH value of less than 5.0.

It is, therefore, the object of the present invention to provide a phosphate electrode and a method for determining a phosphate concentration which have an extremely low cross sensitivity and in particular permit a determination of the phosphate concentration in a wide range of pH values.

This object is solved with the present invention essentially in that a phosphate electrode is provided with a base body and a first coating provided at least on sections of the base body. The base body comprises elemental cobalt, in particular the basic body consists of cobalt at least 90% by weight, preferably at least 95% by weight. Cobalt alloys may also be used. The first coating comprises a cobalt phosphate, in particular Co₃(PO₄)₂, CoHPO₄, or Co(H₂PO₄)₂, preferably CoHPO₄. A second coating, which binds protons and/or releases hydroxide ions, is furthermore provided on at least on sections of the base body and/or the first coating.

The second coating essentially serves to ensure a constant, basic pH value on the surface of the phosphate electrode. According to the invention, this has been found to be sufficient, since the voltage change measured with the phosphate electrode is caused by reactions on the surface of the electrode. Reaching a basic pH value on the surface can be checked by immersing the phosphate electrode in a small volume, for example 50 ml, of a neutral or weakly buffered solution, in particular a highly dilute KCl solution (for example 0.1 10⁻³ mol/L), the pH is increased to at least 7.5. Overall, the cross-sensitivity of a phosphate electrode with a cobalt-based basic body is reduced by adjustment to a basic pH value.

Surprisingly, the cross-sensitivity for other anions of a phosphate electrode is significantly reduced in a basic environment. The second coating provided at least on sections of the base body and/or the first coating maintains a basic environment around the phosphate electrode also in different analytes, i.e. the solutions whose phosphate concentration is to be determined, with different volumes and at least maintained over the measurement period. This avoids costly sampling, adjustment of the pH value in the sample taken and subsequent measurement. Furthermore, an on-line determination of the phosphate concentration in the analyte can be carried out.

Since the release of the hydroxide ions or the bonding of the protons takes place in situ and in the vicinity of the base body or on the surface thereof or the surface of the coatings, the phosphate electrode according to the invention can also be used for determining the phosphate concentration in large volumes, e.g. with more than 1000 L.

In this case, it is sufficient if the basic pH value in the environment is locally adjusted around the phosphate electrode, since the determination of the phosphate concentration is based on a chemical reaction at the surface of the electrode and, therefore, it is important to the measurement conditions locally around these electrodes. It is particularly advantageous that a different average pH value, namely typically 6.5 to 7.0, may be present in the actual analyte, for example the activated sludge of a water treatment plant.

It has also been found that cross-sensitivity of the cobalt-based phosphate electrode can be reduced with respect to the partial pressure of certain gases, in particular oxygen, by adjusting a basic pH value. In this case, it is assumed that the cross-sensitivity, in particular the oxygen, is reduced by a basic pH because fewer protons are available for binding anions, wherein the anions are formed by redox reaction with the electrode surface.

It is preferred if the second coating adjusts a pH value of between 7.5 and 9, in particular between 8 and 9, preferably between 8.2 and 9, particularly between 8.6 and 9, in 50 ml of a very dilute KCl solution (for example, 0.1 mM) at 25° C. The stated values are given with an accuracy of ±0.1. This material property of the second coating can be simply tested by immersing the appropriately constructed phosphate electrode in 1 L of deionized water at 25° C. It has been shown that the lowest cross-sensitivity to the other anions of the phosphate electrode is observed in the indicated range of pH values, whereas the responsivity, i.e. the sensitivity, with respect to phosphate of the electrode is hardly affected.

Furthermore, it is preferred if the second coating comprises a, in particular hydrophilic and/or water-permeable, solid buffer system. A buffering system (or merely buffer) is a mixture of an acid and the corresponding conjugated base, for example an acetic acid/acetate mixture. Buffers are distinguished by the fact that the pH values only slightly change when an acid or a base is added. Therefore, buffers are particularly suitable for setting a basic environment around the phosphate electrode. It is particularly preferred if the acid strength of the acid of the buffer system corresponds to the pH value which is to be adjusted by the buffer system.

Due to the selection of a solid buffer system at standard conditions, i.e. 25° C. and 1 bar of pressure absolute, removal of the buffer via convection in the analyte is prevented or at least rendered difficult, which significantly increases the lifetime of the phosphate electrode.

In a particularly preferred embodiment, the second coating comprises a borosilicate glass. In other words, the borosilicate glass is used as a solid buffer system. The borosilicate glass is used, in particular, as a powder, preferably the borosilicate glass has defined grain sizes, wherein it is preferred if the average grain size is 18 μm and the grain size distribution follows a Gaussian curve. Since borosilicate glasses in general exhibit a basic pH value on their own, they are particularly suitable for the present invention. If the pH value is to be adjusted to the particularly preferred values between 7.5 and 9, 8 and 9, 8.2 and 9 and/or 8.6 and 9, this is achieved, for example, by modifying the borosilicate glasses on the surface. In particular, the borosilicate glass has a modified surface, whereby an adjustment of the pH value by the borosilicate glass is achieved. A modification of the surface may, for example, consist in mixing the borosilicate glass with a solution of a basic or acidic salt, for example sodium acetate or aluminum chloride, and subjecting it to a temperature treatment. This results in a binding of the salt to the borosilicate glass surface. Such production methods are known, for example, from DE 10 2011 011 884 A1.

Another preferred embodiment provides that the second coating comprises a carrier material which has been suitably functionalized to establish a basic pH value. Such a functionalization can be achieved, for example, by the chemical coupling of functional groups, in particular aminoalkylene. Examples of functionalized carrier materials include functionalized silica gel, functionalized graphene, and/or functionalized polystyrene.

Further, it is preferred that the second coating comprises microcapsules. As a result, it is also possible to use volatile, for example liquid, substances for adjustment in order to produce a basic environment for the phosphate electrode, while at the same time preventing too rapid removal of the corresponding substances. In this case, for example, a matrix encapsulation can be used, whereby the corresponding substance is homogeneously mixed with a substance forming the matrix and thus an even distribution is achieved. As a rule, the rate of the release is determined by the diffusion of the substance into the environment or the rate of degradation of the matrix.

In a further development of this idea, it is also possible to manufacture the microcapsules themselves from doped material, for example polymers doped with amino groups. In particular, the capsule material itself can thereby be used as a regulator of the pH value, while the properties of the encapsulated substances and the rate of release of these substances make possible additional adaptations. This makes it possible to produce particularly long lasting microcapsule coatings.

The second coating may be incorporated in filter papers which can be attached to the electrode base body and/or the first coating. For this purpose common filter papers made of cellulose may be used. However, non-biodegradable filter papers are preferred, since these extend the service life of the electrode. Filter papers made of glass fiber have been found to be particularly preferred. Binding agent free filter papers may also be used.

For fixing the second coating, in particular of microcapsules, filter bags are suitable. These filter bags increase the mechanical stability of the second coating, without noticeably affecting the exchange of the analyte and the reactions on the surface of the electrode for phosphate determination. If filter papers made of glass fiber are used, an additional wrapping through a filter bag can be omitted, since these filter papers already have a high mechanical stability.

It has furthermore been found to be advantageous to additionally provide at least one gas supply line connected to a gas source with at least one opening, which is assigned to the electrode. The at least one opening is arranged in such a way that, when a gas, for example air, is introduced into the at least one gas supply line, the base body, in particular the entire phosphate electrode, is surrounded by the introduced gas. A constant partial pressure is thereby produced on the surface of the phosphate electrode by the components contained in the gas. This additionally minimizes cross-sensitivity of the electrode to variable gas partial pressures.

It is particularly preferred that the conducted gas comprises oxygen with which a high cross-sensitivity of common cobalt base phosphate electrodes was observed. Correspondingly, a constant oxygen partial pressure (p(O₂)) can be adjusted and the cross-sensitivity can be further reduced. This is particularly important in the determination of the phosphate concentration in water treatment plants, since the phosphate concentration must be determined both under aerobic and under anaerobic conditions. An opening for each gas line may be provided. Preferably, a plurality of openings are provided for a gas line, wherein it is particularly preferred if the openings are distributed in such a way that a uniform distribution of the introduced gas around the base body is achieved.

Preferably, a phosphate electrode as described above is used to determine the phosphate concentration in the activated sludge of a water treatment and/or waste water treatment plant.

The object underlying the present invention is also solved by a method for determining the phosphate concentration in an aqueous analyte, in particular activated sludge of a water treatment and/or wastewater treatment plant, with the features of claim 8.

In this case, a phosphate electrode, in particular of the type described above, is immersed in an adjusting solution before the determination of the phosphate concentration, namely until the phosphate electrode outputs a measuring signal, which does not change in time. Phosphate and interfering ions are added in the adjusting solution, i.e. all the anions to which the phosphate electrode can exhibit cross-sensitivity, preferably at a concentration as is typically expected in the aqueous analyte. This has the advantage that the phosphate electrode is already “accustomed” to a similar ion level prior to the actual determination of the phosphate concentration. As a result, a short measuring time and high accuracy can be achieved during the determination of the phosphate concentration.

The calibration of the phosphate electrode is preferably also carried out in the adjustment solution by specifically, stepwise varying of the phosphate concentration.

The measurement signal not varying over time is understood to mean that the measuring signal changes only slightly in the case of a given time interval. In particular, the potential change of a phosphate electrode should be less than 1 mV/min, preferably 0.5 mV/min.

It is advantageous if the pH value of the adjusting solution corresponds approximately to the pH of the analyte solution, in particular between 5 and 9, preferably between 7.5 and 9, particularly preferably between 8 and 9, and most preferably between 8.6 and 9. In this case, the cross-sensitivity of the phosphate electrode is extremely small, while the sensitivity of the phosphate electrode to the phosphate is maintained.

It is preferred when the determination of the phosphate concentration is carried out at a constant gas partial pressure, in particular a constant oxygen partial pressure.

In particular, it is preferred that the concentration change of the interfering ions, in particular of divalent anions, preferably sulfate, during the calibration is not more than 2 mM (mM=millimolar, namely 10⁻³ mol/L), preferably not more than 1 mM, particularly preferably 0.5 mM and very particularly preferably not more than 0.2 mM.

Furthermore, it is preferred that the total concentration of the interfering ions, in particular of sulfate, chloride and nitrate, is not more than 100 mM, preferably not more than 50 mM, particularly preferably not more than 30 mM and very particularly preferably not more than 20 mM.

The invention is explained in more detail below with reference to exemplary embodiments and with reference to the drawings. All described and/or illustrated features, independently or in any combination, form the subject matter of the invention independently of their combination in the claims or their backreference.

Shown is:

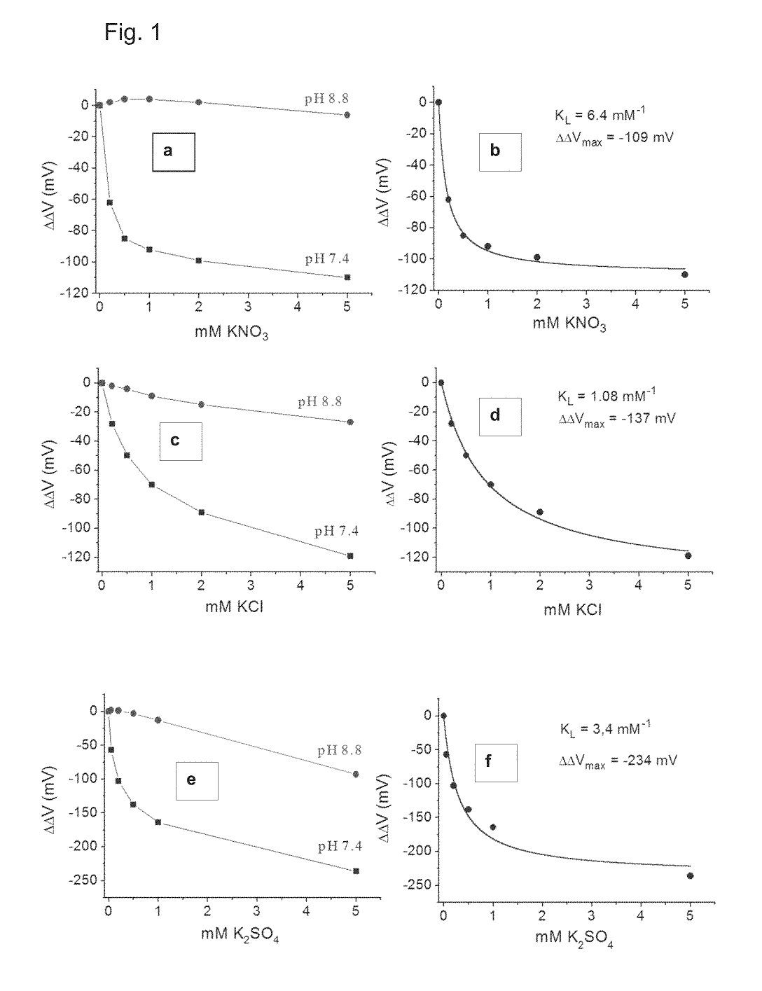

FIG. 1 the voltage change of a half-cell of a phosphate electrode as described in DE 10 2009 051 169 with addition of nitrate (a, b), chloride (c, d) and sulfate (e, f),

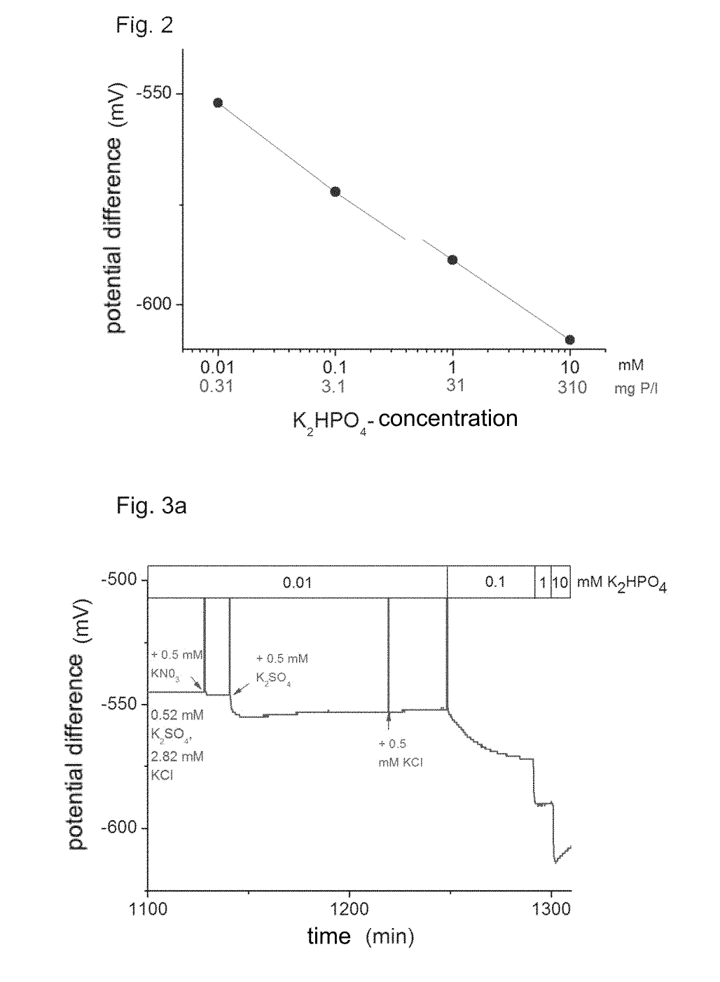

FIG. 2a semi-logarithmic plot of the potential difference as a function of the change in the phosphate concentration at pH=8.8,

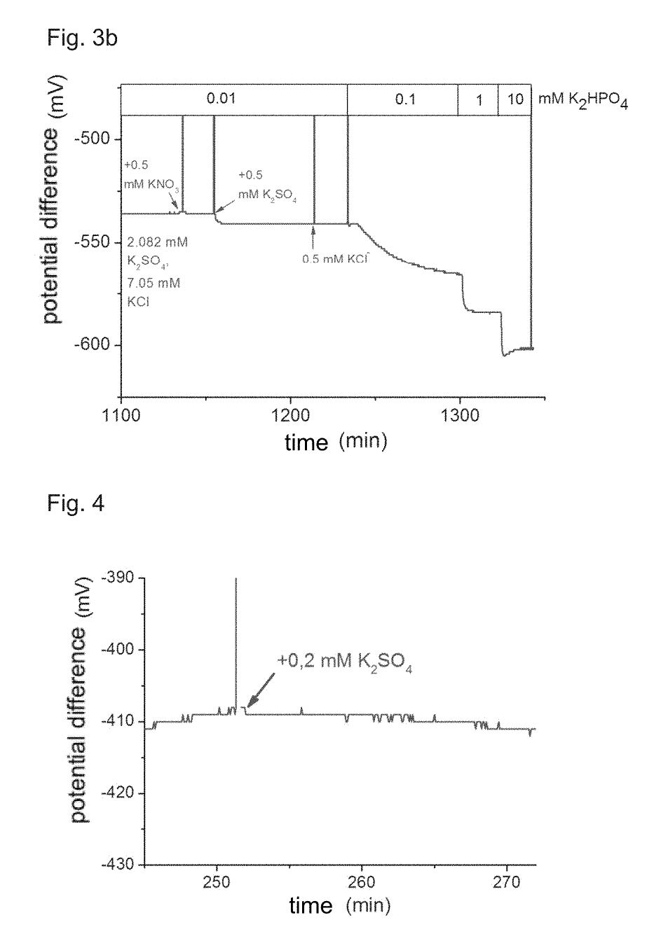

FIG. 3a the change in the potential difference as a function of the addition of interfering ions and the phosphate concentration for an initial concentration of 0.52 mM sulfate, 2.82 mM chloride and 0.01 mM phosphate,

FIG. 3b the change in the potential difference depending on the addition of interfering ions and the phosphate concentration for an initial concentration of 2.08 mM sulfate, 7.05 mM chloride and 0.01 mM phosphate,

FIG. 4 the change in the potential difference as a function of the addition of interfering ions and the phosphate concentration for an initial concentration of 2.08 mM sulfate, 7.05 mM chloride and 0.01 mM phosphate,

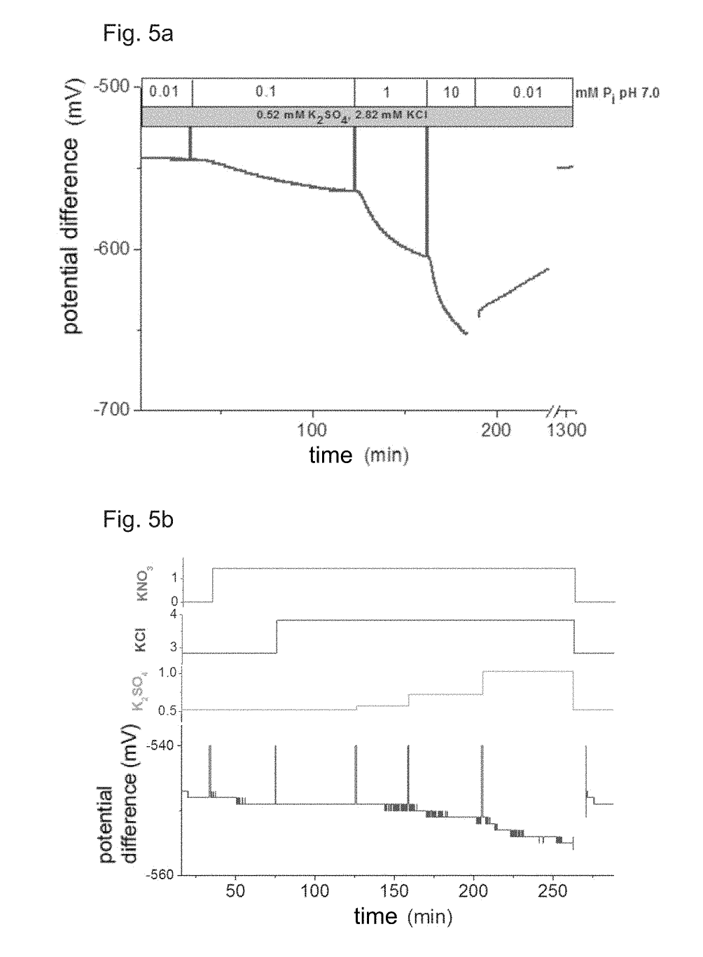

FIG. 5a the change in the potential difference of a phosphate electrode according to the invention as a function of the addition of phosphate for an initial concentration of 0.52 mM sulfate, 2.82 mM chloride and 0.01 mM phosphate,

FIG. 5b the change in the potential difference of a phosphate electrode according to the invention as a function of the addition of interfering ions (representation of the concentration gradient in mM) for an initial concentration of 0.52 mM sulfate, 2.82 mM chloride and 0.01 mM phosphate,

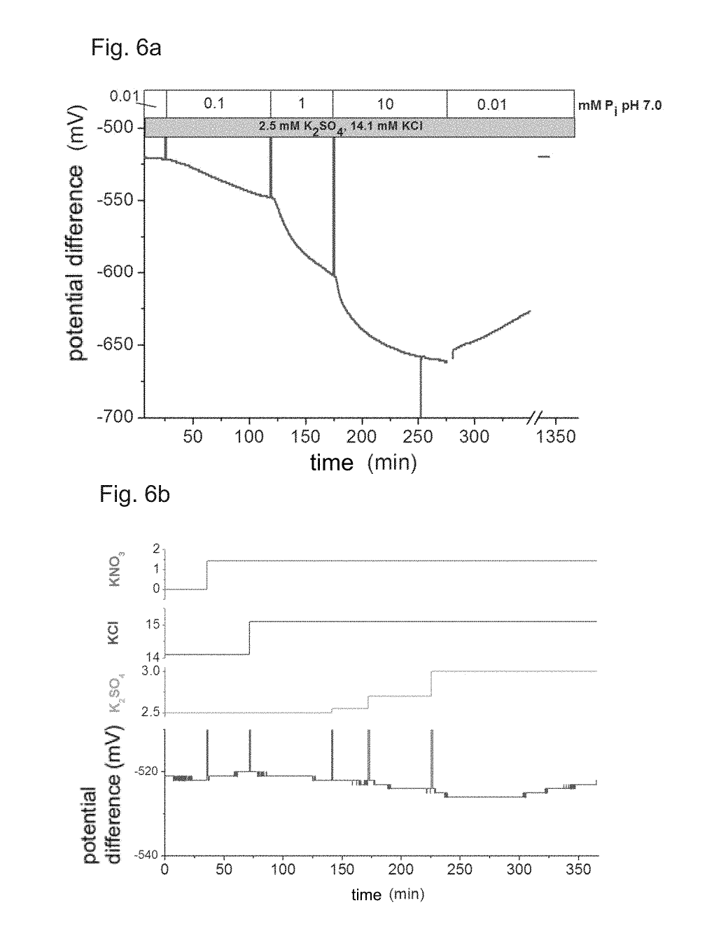

FIG. 6a the change in the potential difference of a phosphate electrode according to the invention as a function of the addition of phosphate for an initial concentration of 2.5 mM sulfate, 14.1 mM chloride and 0.01 mM phosphate,

FIG. 6b the change in the potential difference of a phosphate electrode according to the invention as a function of the addition of interfering ions (representation of the concentration gradient in mM) for an initial concentration of 2.5 mM sulfate, 14.1 mM chloride and 0.01 mM phosphate,

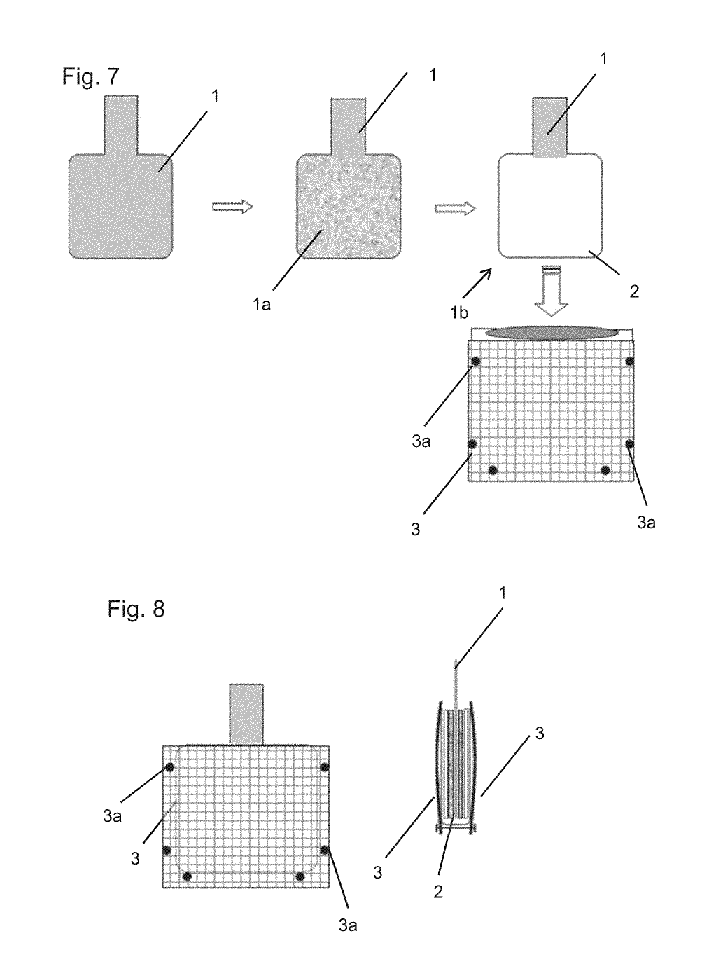

FIG. 7 schematically the structure of a base body with first and second coating,

FIG. 8 schematically shows a base body with coatings constructed as shown in FIG. 7,

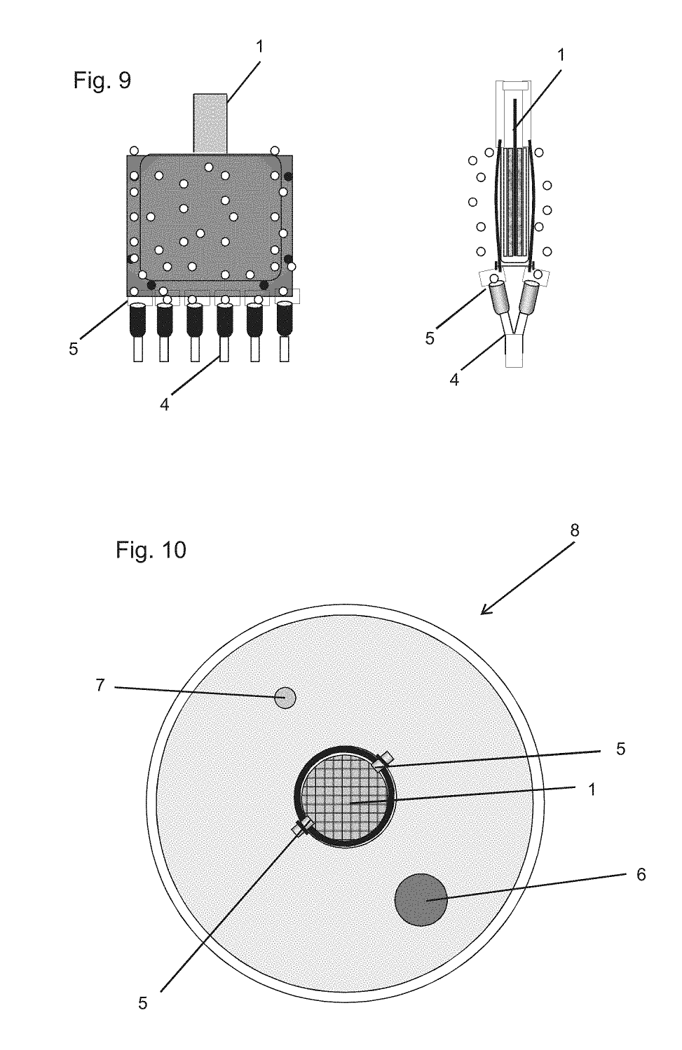

FIG. 9a preferred embodiment of the invention wherein a constant gas partial pressure is generated,

FIG. 10 is a plan view of a phosphate electrode according to a preferred embodiment, and

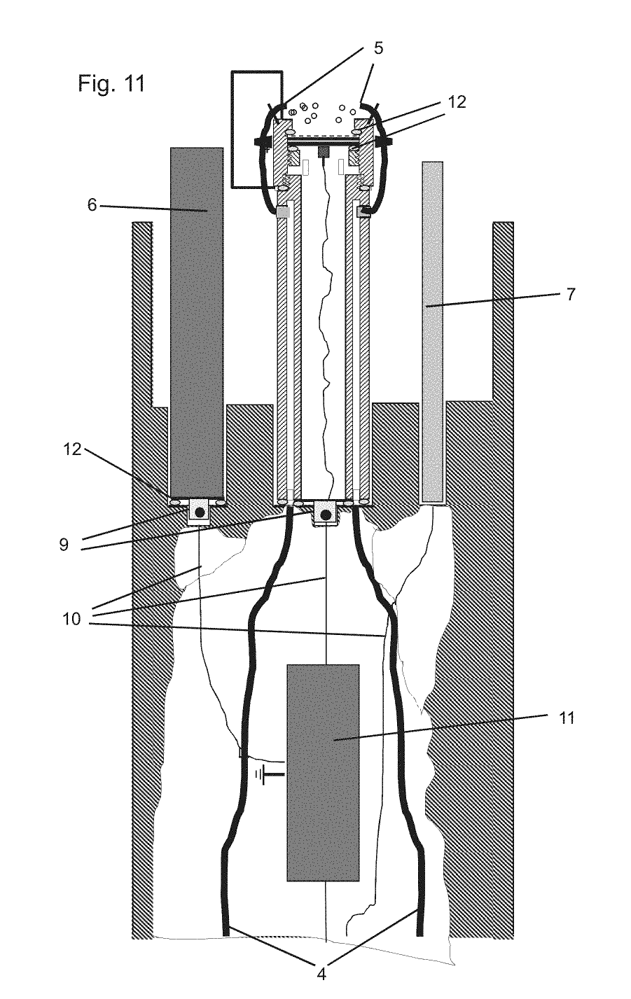

FIG. 11a cross-section of a phosphate electrode as shown in FIG. 10.

FIG. 1 shows the potential difference change ΔΔV as measured by a phosphate electrode according to DE 10 2009 051 169 as a function of different interfering ion concentrations at a pH value of 7.4 and 8.8. The potential difference is determined in this case against a reference electrode whose half-cell potential is not influenced by the phosphate concentration. The analyzed analyte solutions contained dipotassium hydrogenphosphate (K₂HPO₄) with a concentration of 0.01 mM. The interfering ions nitrate (a, b), chloride (c, d) and sulfate (e, f) were added in the indicated concentrations. The potential difference ΔΔV was recorded outgoing from an initial value (ΔΔV=0). A significant change in the voltage difference was observed for all interfering ions at a pH of 7.4. This shows that the prior art phosphate electrode has a strong cross-sensitivity to other anions.

The potential difference change at pH=7.4 follows essentially a saturation kinetic and can be described very well with the Langmuir equation used in the absorption processes:

$$ΔΔ V = \frac{{K}_{L} \cdot Δ Δ {V}_{max} \cdot {c}_{A}}{1 + {K}_{L} \cdot {c}_{A}}$$

K_{L} is the bond constant for the interfered interstitial ion, ΔΔVₘₐₓ is the maximum deflection of the potential difference and c_{A} the concentration of the interfering ion. The matching of a corresponding Langmuir equation and the obtained binding constant for the investigated interfering ion are also shown in FIG. 1 for pH=7.4 (b, d, f). Correspondingly, for neutral environments at pH=7.4, the interfering ions on the phosphate electrode appear to be absorbed, which leads to an undesirable change in the potential difference and makes the determination of the phosphate concentration considerably more difficult.

At an elevated pH of 8.8, the electrode's response to increasing chloride, nitrate and sulfate concentrations is strongly damped compared to more neutral conditions (pH=7.4). Especially in the lower concentration range (<1 mM) hardly any change in the potential difference is observed.

At the same time, the sensitivity for phosphate is maintained, as shown in FIG. 2. For a pH value of 8.8, the voltage difference is determined as a function of the phosphate concentration. In the semi-logarithmic plot shown, a linear progression is observed, where the slope corresponds to a value which would typically be expected under these conditions for a divalent anion (here: the hydrogen phosphate HPO₄²⁻).

In a further series of experiments, the phosphate electrode was examined for the effect of a change in concentration of anions on the electrode potential. The results are shown in FIG. 3.

Two ion environments (a, b) were tested, which can simulate, for example, the situation in the sewage water of a water treatment plant. In the results shown in FIG. 3a, 0.52 mM of sulfate and 2.92 mM of chloride were added to the analyte solution. In the results shown in FIG. 3b, 2.08 mM of sulfate and 7.05 mM of chloride were added to the analyte solution. Both represent extreme cases of typical interfering ion concentrations, a typical minimum concentration being shown in FIG. 3a and a typical maximum concentration in FIG. 3b. In particular, such interfering ion concentrations are present in the phosphate concentration determination in water treatment plants. In both situations (a and b), the addition of nitrate (as potassium nitrate) and chloride (as potassium chloride) did not have any measurable effect on the electrode potential. The change in the phosphate concentration (upper axis), however, caused the expected potential change, demonstrating that the electrode can be used to determine the phosphate concentration.

A sulfate addition of 0.5 mM caused a slight potential change (FIGS. 3a and b). At lower changes in sulfate concentration (FIG. 4), however, no potential changes were recorded. In general, it has been found that the higher the starting concentration of the corresponding interfering ion or all interfering ions, the lower the potential change due to a certain interfering ion concentration change is. This observation is explained by saturation effects.

These results show that at a suitable pH value, in particular of approximately 8.8, the cross-sensitivity of the phosphate electrode to the constitutively occurring interfering ions is reduced and the phosphate concentration determination is only insignificantly impaired. The stated pH value represents an optimum. If the pH value is increased to values >9, the potential change of the phosphate electrode decreases with respect to a change in the phosphate concentration so that the phosphate electrode loses its sensitivity.

FIG. 5a shows the potential change in the course of the measurement time of a phosphate electrode according to the invention at a disturbance ion concentration of 0.52 mM K₂SO₄ and 2.82 mM KCl with a changing the phosphate concentration (upper axis). It becomes apparent that the phosphate electrode according to the invention is suitable for determining the phosphate concentration. The calibration curve of the phosphate electrode according to the invention obtained from the measured data is shown as an insertion. From a measurement time of approx. 200 min, the phosphate electrode was transferred to a further solution with the initial concentration of 0.01 mM phosphate. An increase in the measured potential difference (in mV) was observed. After a measurement time of at most 1300 minutes, the measured potential difference of the phosphate electrode according to the invention is returned to the starting value (for 0.01 mM phosphate). This demonstrates the function and good reversibility of the phosphate electrode according to the invention.

FIG. 5b shows the potential change of a phosphate electrode according to the invention at an interfering ion concentration of 2.08 mM sulfate and 7.05 mM chloride as a function of the concentration of KNO₃, KCl and K₂SO₄. It becomes clear that the addition of further interfering ions leads only to negligible potential changes. Thereby the highest remaining cross-sensitivity for the divalent sulfate is observed. An addition of 1.02 mM K₂SO4 (to a total of 3.1) leads to a potential change below 10 mV, which results in a small measurement error with respect to the phosphate concentration.

FIGS. 6a and b show, analogously to FIG. 5, the potential change of a phosphate electrode according to the invention with a higher interfering ions concentration. As interfering ions, 2.5 mM K₂SO₄ and 14.1 mM KCl were introduced into the analyte solution. FIG. 6a again shows the change in the potential with changing phosphate concentration. In addition, the reversibility of the potential change was also tested by transferring the phosphate electrode according to the invention into a solution with a concentration of 0.01 mM phosphate at a measurement time of 275 min. Here again, after a measuring time of at the latest 1350 min, the output value at 0 min measuring time is reached.

FIG. 6b shows the change in the potential at the same interfering ions concentration as FIG. 6a and the indicated interfering ions concentrations. The low influence of the interfering ions on the potential of the phosphate electrode according to the invention is also evident here.

FIG. 7 shows schematically the structure of a base body 1 made of cobalt of a phosphate electrode according to the invention with a first coating 1a and a second coating 1b. The second coating 1b is preferably hydrophilic and waterpermeable, which facilitates the diffusion of phosphate onto the base body or the first coating 1a. In addition, the second coating 1b must establish a basic pH value in the electrode environment and should quickly compensate for changes in the pH value in the boundary layer of the electrodes surface. In a preferred embodiment, pulverized borosilicate glass is used for the second coating, e.g. as offered by Trovotech GmbH (Edisonstr.3, D-06766 Bitterfeld-Wolfen). Said company produces borosilicate glass powder in defined grain sizes, wherein the pH value in the boundary layer can be adjusted in a targeted manner by chemical modification of the particle surface.

FIGS. 7 and 8 schematically illustrate a preferred, already tested construction of the base body 1 with coatings 1a and 1 b of a phosphate electrode according to the invention. The other measurement setup corresponds to the specifications in DE 10 2009 051 169 and is typical for ion-selective electrodes. A mixture of cobalt powder (Fluka®. 60784, Sigma-Aldrich®) and cobalt hydrogen phosphate (mixing ratio 1:1) is applied as coating onto a cobalt plate (thickness 0.1 mm, from Alfa-Aesar®, Karlsruhe) to obtain a first coating 1a on the base body 1. Then, a second coating 1b comprising the borosilicate glass powder (TROVOpowder® B-K20_8.8) was applied. For this purpose, the borosilicate glass powder was suspended in water and the suspension was applied with a Pasteur pipette onto a filter paper of glass fiber (which was adapted to the dimensions of the electrode, MN85/70, from Macherey-Nagel, Duren). The glass particles are transported with the penetrating water into the filter pores and fixed therein. Powder remaining on the surface is carefully spread out with a spatula and powder residues are removed. The thus prepared filter paper is then applied on both sides to the base body 1 and the first coating 1a in a moist state, and is then immediately introduced into a filter pocket 2 made of cellulose. Two hard plastic meshes 3, which are rigidly connected to each other by clamps 3a and mechanically stabilize the coatings 1a and 1 b, are finally attached as an outer boundary.

In another variant, the base body 1 and the first coating 1a are separated from the second coating 1b, in particular a borosilicate layer, by a fine-pore, hydrophilic membrane (for example, of synthetic fiber) of a few μm thickness (not shown).

In a further, preferred version, only non-biodegradable material is used, which has a favorable effect on the stability and the lifetime of the electrode. For example, filter bags 2 made of synthetic fibers are used instead of those made of cellulose. Further, filter papers of glass fiber, e.g. Munktell 3.1101.047 of thickness 250 μm from the company Munktell Filter AB may be used. If a filter paper made of glass fiber is used, an additional wrapping by a filter bag can be omitted, which allows a more cost-effective production of the electrode. In addition, the liquid exchange between the electrode surface and the analyte solution can be improved.

In a further variant, instead of borosilicate glass powder, microparticles are used, whose surface has been doped with amino groups in order to buffer the local pH value in the basic range. These microcapsules may be coated and/or filled such that they continuously release hydroxide ions.

FIG. 9 schematically shows a base body 1 (with coatings) according to FIG. 8 and additional gas line 4 with corresponding opening 5 in two perspectives. In this case, an opening 5 can be provided for each gas line 4 as well as a plurality of openings 5 for a gas line 4. An oxygen-containing gas, in this case air, is passed through the gas line 4, for example a commercially available PVC hose, and is distributed via opening 5 in the vicinity of the phosphate electrode according to the invention. This is shown schematically in FIG. 9 by the circles. Thereby, a constant oxygen partial pressure (pO₂) is set in the vicinity of the phosphate electrode, and the cross-sensitivity of the electrode potential against the oxygen in the analyte can be reduced. For introducing the air, for example, a commercially available aquarium pump can be used.

A supply of oxygen-containing gas around the phosphate electrode is particularly advantageous when the oxygen partial pressure on the electrode surface deviates strongly from that in the analyte (for example, under anaerobic conditions in the clarification basin of a sewage treatment plant).

FIGS. 10 and 11 show schematically a preferred embodiment of the phosphate electrode.

FIG. 10 shows a plan view of a phosphate electrode according to the invention with an additional gas feed line (PVC hose) with openings 5, reference electrode 6, additional temperature sensor 7 and phosphate electrode measuring head 8.

FIG. 11 shows a cross-section of the phosphate electrode shown in FIG. 10. As described above, the base body 1 has two coatings, is arranged horizontally in the image plane and forms the reactive surface of the phosphate electrode on the side facing the analyte. A basic pH value of above 7.4 (namely between 7.5 and 9) is generated around this surface by the second coating (not shown). In addition, air is released via the gas line 4 on the reactive surface of the base body 1, as a result of which a constant oxygen partial pressure is generated in the phosphate electrodes environment.

Both the reference electrode 6 and the phosphate electrode measuring head 8 are connected via BNC sockets 9 and cables 10 to a preamplifier 11. which amplifies the measurement signal and outputs it to an amplifier (not shown). For sealing the electronic components, a plurality of sealings 12 are provided, which prevent the analyte from penetrating into the electrode.

### LIST OF REFERENCE NUMERALS

1 base body
1a first coating
1b second coating
2 filter bag
3 hard plastic mesh
3a clamps
4 gas feed line
5 opening
6 reference electrode
7 temperature sensor
8 phosphate electrode measurement head
9 BNC connectors
10 cable
11 preamplifier
12 sealing

1-10. (canceled)

11. A phosphate electrode with a base body and a first coating (1a) provided at least on sections of the base body, wherein the base body comprises elementary cobalt and the first coating (1a) comprises a cobalt phosphate, characterized in that at least on sections of the base body and/or the first coating (1a) a second coating (1b) is provided, which binds protons and/or releases hydroxide ions.

12. Phosphate electrode according to claim 11, characterized in that the second coating (1b) sets a pH value between 7.5 and 9 in 50 ml of a 0.1 mM KCl solution at 25° C.

13. Phosphate electrode according to claim 11, characterized in that the second coating (1b) comprises a solid buffer system.

14. Phosphate electrode according to claim 11, characterized in that the second coating (1b) comprises a borosilicate glass, microcapsules and/or a functionalized carrier material.

15. Phosphate electrode according to claim 11, characterized in that the second coating (1b) comprises a borosilicate glass.

16. The phosphate electrode according to claim 11, characterized in that at least one gas feed line is provided with at least one opening, wherein the at least one opening is arranged such that, when a gas is introduced into the gas feed line the gas escapes from the at least one opening and flows around the base body.

17. Use of a phosphate electrode according to claim 11, for the determination of the phosphate concentration in activated sludge of a water treatment and/or sewage treatment plant.

18. Method for the determination of the phosphate concentration in an aqueous analyte with a phosphate electrode, characterized in that the phosphate electrode is immersed in an adjusting solution before the phosphate concentration is determined until the phosphate electrode outputs a measuring signal which does not vary with time, wherein Interfering ions and phosphate were added to the adjusting solution.

19. The method as claimed in claim 18, characterized in that the pH of the adjusting solution is between 5 and 9.

20. The method as claimed in claim 18, characterized in that the determination of the phosphate concentration is carried out at a constant gas partial pressure.
